(19) United States
(12) Patent Application Publication
(10) Pub. No.: US 2023/0264126 A1
(43) Pub. Date: Aug. 24, 2023

(54) LOGIC FOR CONTROL OF WATER FLOW THROUGH A SCREEN ASSEMBLY

(71) Applicants: Terry Duperon, Saginaw, MI (US); Kenneth Blanchard, Sanford, MI (US); Bryce Funchion, Tecumseh, MI (US)

(72) Inventors: Terry Duperon, Saginaw, MI (US); Kenneth Blanchard, Sanford, MI (US); Bryce Funchion, Tecumseh, MI (US)

(21) Appl. No.: 18/305,597

(22) Filed: Apr. 24, 2023

Related U.S. Application Data
(63) Continuation-in-part of application No. 16/953,536, filed on Nov. 20, 2020, now abandoned.

(51) Int. Cl. B01D 37/04; C02F 1/00; B01D 29/44; B01D 29/60

(52) U.S. Cl. CPC B01D 37/045; C02F 1/001; C02F 1/008; B01D 29/445; B01D 29/605; C02F 2209/40; C02F 2209/006

(57) ABSTRACT

A logic that is used in water bar screen assemblies to control the flow of water through the assembly and to methods.

### CROSS-REFERENCE TO RELATED APPLICATIONS

This application is a continuation-in-part utility application from U.S. patent application Ser. No. 16/953,536, filed Nov. 20, 2020, from which priority is claimed.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The instant invention deals with logic that is used in water bar screen assemblies to control the flow of water through the assembly. Devices useful in the screening of water and the methods used to operate a screen in a water or waste water stream are known. Such methods are used in a variety of applications including pump stations, fresh and saltwater intake systems, storm sewage outfall, combined sewage outfall, wastewater treatment, industrial water and wastewater treatment systems.

Screen types on such systems consist of screening media constructed of perforated panels, slotted panels, bars, wire mesh and other types of such screening media. The trend has been to leave openings in the screen that are smaller and smaller in order to take more debris out of the water.

The screens are typically cleaned using some method to allow more throughput of water. Such methods can are for example, spraying with water, rotating brushes, wiper blades, scrapers, or a combination of these methods. Debris removal equipment is thus defined as spraying with water, rotating brushes, wiper blades, scrapers, or a combination of these methods.

### BRIEF SUMMARY OF THE INVENTION

The instant invention deals with a logic that is used in water bar screen assemblies to control the flow of water through the assembly and to methods therefor.

Thus, this invention deals with a method of controlling the flow of water through a bar screen assembly positioned in the water, the method comprising using the logic set for herein.

This invention uses a bar screen water assembly controlled by the logic in FIG. 1, wherein the bar screen water assembly is relatively consistent with the bar screen assembly found in U.S. Pat. No. 5,425,875 that issued Jul. 18, 2017, to Terry Duperon et al.

Another embodiment of this invention is logic for controlling a water screen assembly, said logic following a flow chart as set forth in FIG. 1.

### BRIEF DESCRIPTION OF THE SEVERAL VIEWS OF THE DRAWING(S)

FIG. 1 is a flow illustration diagram of the logic used in the instant invention.

FIGS. 1A to 1G illustrate this invention.

FIG. 1A (box 1) illustrates normal speed of debris removal equipment.

FIG. 1B (box 2) illustrates a high speed of debris removal equipment.

FIG. 1C (box 3) illustrates a first screen opening.

FIG. 1D (box 4) illustrates when the speed event of 1B subsides.

FIG. 1E (box 5) illustrates when the screen of Box 3 closes.

FIG. 1F (box 6) illustrates when the speed of the debris removal equipment reduces speed.

FIG. 1G (box 7) illustrates when the debris removal equipment reverts to normal speed of box 1.

FIG. 2 is a water screening assembly found in U.S. Pat. No. 9,707,496. (Prior Art).

### DETAILED DESCRIPTION OF THE INVENTION AND DRAWINGS

The detailed description of the instant invention can best be understood with regard to an understanding of the apparatus described in the aforementioned U.S. patent that is equipped with a vertical bar screen apparatus.

The essence of the instant invention is the use of specific logic to control the bar screen activity wherein, the logic has the ability to control the movement of a certain number of bars of the bar screen, and the ability to control the amount of opening left by the vacant bars by closing the certain lifted bars to specific opening size. The control of these openings is ultimately controlled by the head differential of the water flowing through the screen. When a head differential in front of the screen is higher relative to the level of the water behind or below the screen, the control logic can regulate the bar openings to reduce the head differential across the screen by the flow of water. It needs to be noted that the opening of the active bar field changes the bar opening and this function is only available on certain bar screen designs.

Thus, there is an upstream water level detector (sensor) which detects the water level upstream of the screen apparatus and a downstream water level detector which detects the water level downstream of the screen. There is a flow determining device that determines the volumetric flow through the screen and there is a blockage determination unit which determines a percentage of the screen blockage based on the water level upstream of the screen, the water level downstream of the screen, and the volumetric flow of the water.

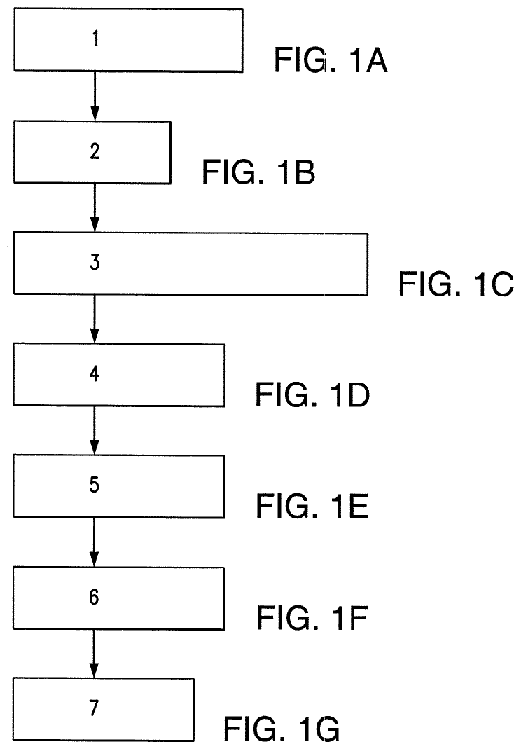

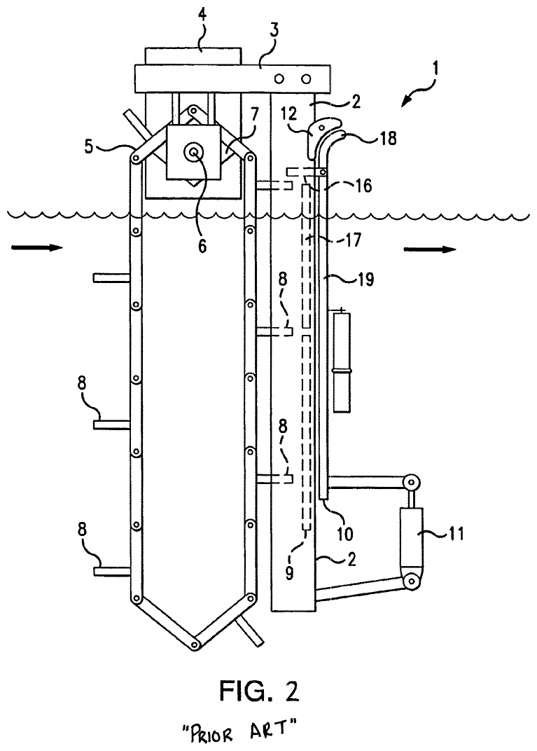

Turning now to FIGS. 1A to 1G, which is a schematic illustration of a flow diagram illustrating the logic used in the instant invention. There is shown a transition between box 1 and box 2 detecting an increase in the head differential through screen blockage or increased flow rate of water. For purposes of this invention there is a head differential range of typically 0 to 24 inches within which the control sequence operates. The instant invention is not limited to this range.

Bar screens are usually designed with a peak flow in mind. This creates multiple issues with the design conditions for the site. Potentially the peak flow hydraulics are ideal, while the lower more normal average flow velocities are slow and create settling issues throughout the sewer system. Additionally, if the design does not take into account the peak flow of the wastewater channel, the screen could have high flow velocities producing pull through of debris and potentially sewer overflows.

The invention disclosed here provides a solution for the peak flow events while being able to maintain velocities and produce maximum capture during lower, more frequent flows.

In order to achieve this, the water assembly must have the ability to change screen openings. During normal flows, the screen opening can be designed to screen to the finest opening available to maximize capture. Then during peak events the screen field has the ability to transition to a new bar opening based on head differential and flow to the bar screen.

Turning to FIG. 1, there is shown 7 boxes numbered from 1 to 7. The logic therein is defined as follows. During normal everyday flows the bar screen runs at normal flow speed with the finest openings in the screen being used (FIG. 1A). The screen operates with minimal head differential typically measured between 0 to 3 inches.

Box 2 operates to increase the speed of any scrapers or wipers on the screen to remove debris blockage while box 3 operates to monitor and sense continued increase in the head differential. For purposes of this invention, at this stage, the head differential operates in about the 6 to 24 inch range.

Box 4 illustrates the apparatus scrapers increased speed, even to maximum speed if required to attempt to clear the apparatus to increase the flow of water and achieve the desire level of head

differential that can be achieved. At this point, the head differential range is about 8 to 36 inches.

Failing to achieve the desired level of head differential box 6 opens the screen by elevating a specific number of bars (even 100% of them if needed) out of the forward flow of the water, which lowers the head differential/upstream water level (box 7). At this point, if the head differential is lowered to a range of about 3 inches to 12 inches, the screen is closed.

As the event starts to build, the upstream water level has the potential to rise due to binding of debris and the hydraulic capacity of the bar screen. Once the differential rises above typically 3 inches, the programmable logic controller (PLC) will signal the bar screen to speed up to prevent any further increases in differential by reducing binding. During this time, the debris concentration will be high due to flushing of settled debris within the sewer system. If the event continues and peak flows are realized, the head differential may continue to rise (FIG. 1C). When the differential increases to typically over 6 inches, the bar screen will transition the bar openings to allow additional flow while maintaining velocities through the screen. The speed of the debris removal equipment remains in high speed throughout this event.

The speed event subsides and transitions into FIG. 1D.

As the event subsides the head differential will begin to lower typically to 6 inches. The PLC will trigger the bar screen to close and return to the original screen opening. At this time, the differential has returned to being managed by the speed of the debris removal equipment thereby reducing the binding effect. As the differential continues to fall below typically 3 inches, the debris removal equipment will then return to the normal low speed of normal operation. (FIG. 1A).

In the event that debris becomes lodged in the screen field as it is pivoted away, then the last operation is to use the alternate closing method of this invention, of stopping the raised screen from closing all of the way. For purposes of this invention, this is done desirable, sequentially, but not necessarily so.

What is claimed is:

1. A method of controlling the flow of water through a bar screen assembly positioned in said water, said method comprising using the logic of the flow diagram in FIG. 1.

2. A bar screen water assembly controlled by the logic in FIG. 1.

3. Logic for controlling a water screen assembly, said logic following the flow diagram of FIG. 1.
